(19) United States
(12) Patent Application Publication
(10) Pub. No.: US 2021/0087659 A1
(43) Pub. Date: Mar. 25, 2021

(54) Fuel Delivery Rail and Method of Making Same

(71) Applicant: Trenton Forging Company, Trenton, MI (US)

(72) Inventors: David Moxlow, Trenton, MI (US); Richard Hudock, Trenton, MI (US)

(73) Assignee: Trenton Forging Company, Trenton, MI (US)

(21) Appl. No.: 16/579,737

(22) Filed: Sep. 23, 2019

(51) Int. Cl. C22C 38/04; F02M 63/02

(52) U.S. Cl. CPC C22C 38/04; F02M 2200/80; F02M 2200/9061; F02M 63/0225

(57) ABSTRACT

A fuel delivery rail includes a rail body having an outer diameter and an inner diameter. The inner diameter defines an interior channel. The fuel delivery rail includes an input port providing access to the interior channel for fuel to enter the interior channel. A plurality of output ports allow the fuel to exit the interior channel, wherein the fuel deliver rail is fabricated from a microalloy steel comprising the following composition by weight: 0.28%<carbon<0.31%; 0.65%<silicon<0.80%; 1.40%<manganese<1.50%; 0.0%<phosphorus<0.015%; 0.012%<sulfur<0.025%; 0.15%<chromium<0.25%; 0.12%<vanadium<0.15%; 0.0%<molybdenum<0.05%; 0.0%<nickel<0.10%; 0.008%<titanium<0.015%; 0.015%<nitrogen<0.020%; 0.0%<aluminum<0.01%; 0.0%<copper<0.25%, the remainder being iron and impurities inherent in processing.

### BACKGROUND ART

### 1. Field of the Invention

The invention relates generally to fuel delivery rails for internal combustion engines. More particularly, the invention relates to a method of manufacturing fuel delivery rails for internal combustion engines.

### 2. Description of the Related Art

Fuel delivery rails are devices that facilitate the distribution of fuel to the individual cylinders of an internal combustion engine. Generally, the fuel delivery rail has a single input port and multiple output ports. Because the fuel for an internal combustion engine is delivered to the cylinders under pressures in the range of 3,000-4000 psi, the fuel delivery rail must be forged to maintain pressures reaching these levels.

U.S. Pat. No. 8,176,898 discloses a fuel delivery pipe. This fuel delivery pipe or rail achieves the necessary hardness through extended heat treatments. As such, there is a need for a fuel delivery rail that can obtain hardness levels with minimized heat treatment.

### SUMMARY OF THE INVENTION

A fuel delivery rail includes a rail body having an outer diameter and an inner diameter. The inner diameter defines an interior channel. The fuel delivery rail includes an input port providing access to the interior channel for fuel to enter the interior channel. A plurality of output ports allows the fuel to exit the interior channel, wherein the fuel delivery rail is forged from a microalloy steel comprising the following composition by weight:

0.28%<carbon<0.31%

0.65%<silicon<0.80%

1.40%<manganese<1.50%

0.0%<phosphorus<0.015%

0.012%<sulfur<0.025%

0.15%<chromium<0.25%

0.12%<vanadium<0.15%

0.0%<molybdenum<0.05%

0.0%<nickel<0.10%

0.008%<titanium<0.015%

0.015%<nitrogen<0.020%

0.0%<aluminum<0.01%

0.0%<copper<0.25%, the remainder being iron and impurities inherent in processing.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of a fuel delivery rail according to one embodiment of the invention; and

FIG. 2 is a top view of the embodiment shown in FIG. 1.

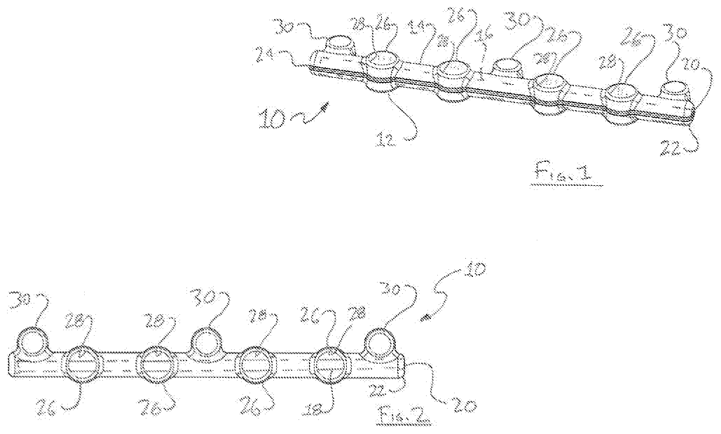

### DETAILED DESCRIPTION OF THE PREFERRED EMBODIMENT

Referring to the Figures, one embodiment of a fuel delivery rail is generally shown at 10. The fuel delivery rail 10 includes a rail body 12 having an outer diameter 14 and an inner diameter 16. The inner diameter 16 defines an interior channel 18. The interior channel 18 extends along the entire rail body 12. An input port 20 provides access to the interior channel 18 at a fuel line end 22 of the rail body 12. The rail body 12 extends from the fuel line and 22 to a distal end 24. In the embodiment shown, the distal end 24 is closed. In an alternative embodiment (not shown) the distal end 24 may be open.

A plurality of output ports 26 are in fluid communication with the interior channel 18 of the fuel delivery rail 10. The output ports 26 provide a means by which individual fuel injectors may be connected between the fuel delivery rail 10 and each cylinder of the internal combustion engine (not shown) to which the fuel delivery rail 10 is attached. Means by which these fuel injectors are connected to the fuel delivery rail 10 are through a threaded engagement or compression socket along an interior wall 28 of each of the plurality of output ports 26.

Extending out from the outer diameter 14 of the rail body 12 are a plurality of attachment bosses 30. The attachment bosses 30 allow the fuel delivery rail 10 to be secured to the internal combustion engine to which the fuel delivery rail 10 is delivering fuel. It should be appreciated by those skilled in the art that the fuel delivery rail 10 may be secured to another structure within an engine compartment housing an internal combustion engine. The attachment bosses 30 may be drilled out to allow bolts to extend therethrough in such a manner that the bolts threateningly engage the structure to which it is to be secured. In the embodiment shown in the figures, there are three attachment bosses 30. The number of attachment bosses 30 are predicated on the actual design and length of the fuel delivery rail 10.

In operation, a fuel line (not shown) is secured to the input port 20 of the rail body 12. The fuel line may connect the rail body 12 to a fuel injection system, which may get its source of fuel from a fuel tank. The fuel injection system sends pressurized fuel into the interior channel 18 of the fuel delivery rail 10. The interior channel 18 is designed such that the fuel exits through each of the plurality of output ports 26 equally.

The fuel delivery rail 10 is forged from a microalloy steel. The fuel delivery rail 10 incorporates the microalloy steel allowing the fuel delivery rail 10 to be forged through a process that reduces the heat treatment thereof. The fuel delivery rail 10 is subjected to controlled cooling using a method that will provide a specific hardness to the fuel delivery rail 10 upon its formation. As such, the fuel delivery rail 10 will have a hardness level sufficient to maintain the fuel at pressures at or about 3,000 psi, the pressure necessary to operate in conjunction with the internal combustion engine over the life of the internal combustion engine.

The microalloy steel having the following chemistry:

0.28%<carbon<0.31%; 0.65%<silicon<0.80%; 1.40%<manganese<1.50%; 0.0%<phosphorus<0.015%; 0.012%<sulfur<0.025%; 0.15%<chromium<0.25%; 0.12%<vanadium<0.15%; 0.0%<molybdenum<0.05%; 0.0%<nickel<0.10%; 0.008%<titanium<0.015%; 0.015%<nitrogen<0.020%; 0.0%<aluminum<0.01%; 0.0%<copper<0.25%; with the remainder being iron and impurities inherent in processing.

The steel used is bar steel that is billet cast and has a minimum of a 7 to 1 reduction drawn from cast to hot rolled bar. The bar conforms to ASTM A29 for dimensional characteristics and has a grain size of “Fine” as defined by ASTM E-112.

The method of manufacturing a fuel delivery rail 10 as described above and including the above-listed composition includes the step of heating steel to within a range between 2,200° F. and 2,400° F. Once heated, the steel is forged into the shape of the fuel deliver rail 10. After the steel has been forged according to design, it enters a first cooling stage where the forged part is cooled to approximately 1,150° F. This cooling step may extend through an approximate range between 200 seconds and 300 seconds. After the forged part exits the first cooling stage, it enters a second cooling stage where the forged part is cooled to a temperature of approximately 800° F. During the second cooling stage, the forged part is cooled in a time range approximately between 400 seconds and 600 seconds. When completed, the steel fuel delivery rail 10 is cooled to room temperature and has a hardness in a range between 264 and 286 kgf/mm².

By using the steel described above and cooling the steel through a two-stage cooling (excluding the cooling to room temperature), the method eliminates a subsequent heat treatment step allowing the forged steel to reach hardness levels only attainable through a method requiring additional heat treatment steps. With one of the heat treatment steps eliminated, the forged steel fuel delivery rail can be made quicker and more cost effectively.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A fuel delivery rail comprising:
a rail body having an outer diameter and an inner diameter, said inner diameter defining an interior channel;
an input port providing access to said interior channel for fuel to enter said interior channel;
a plurality of output ports allowing the fuel to exit said interior channel, wherein said fuel delivery rail is forged from a microalloy steel comprising the following composition by weight:
0.28%<carbon<0.31%
0.65%<silicon<0.80%
1.40%<manganese<1.50%
0.0%<phosphorus<0.015%
0.012%<sulfur<0.025%
0.15%<chromium<0.25%
0.12%<vanadium<0.15%
0.0%<molybdenum<0.05%
0.0%<nickel<0.10%
0.008%<titanium<0.015%
0.015%<nitrogen<0.020%
0.0%<aluminum<0.01%
0.0%<copper<0.25%, the remainder being iron and impurities inherent in processing.

2. A fuel delivery rail as set forth in claim 1 having a hardness in a range between 264 and 286 kgf/mm².

3. A method for manufacturing a fuel delivery rail comprising the steps of:
heating steel to within a range between 2,200° F. and 2,400° F., wherein the steel has a chemical composition by weight:
0.28%<carbon<0.31%
0.65%<silicon<0.80%
1.40%<manganese<1.50%
0.0%<phosphorus<0.015%
0.012%<sulfur<0.025%
0.15%<chromium<0.25%
0.12%<vanadium<0.15%
0.0%<molybdenum<0.05%
0.0%<nickel<0.10%
0.008%<titanium<0.015%
0.015%<nitrogen<0.020%
0.0%<aluminum<0.01%
0.0%<copper<0.25%, the remainder being iron and impurities inherent in processing;
forging the steel into the fuel delivery rail;
first cooling the steel to approximately 1,150° F.; and
second cooling the steel to approximately 800° F. to create the fuel delivery rail having a hardness in a range between 264 and 286 kgf/mm².

4. A method as set forth in claim 3 wherein the step of first cooling extends through approximately 200 and 300 seconds.

5. A method as set forth in claim 4 wherein the step of second cooling extends through approximately 400 and 600 seconds.

6. A method as set forth in claim 5 including a third cooling step to cool the steel to room temperature.
